(19) United States
(12) Patent Application Publication
(10) Pub. No.: US 2006/0242043 A1
(43) Pub. Date: Oct. 26, 2006

(54) Method for predicting option performance

(75) Inventors: Brian P. Sloyer, Oldsmar, FL (US); William C. Faassen, Oldsmar, FL (US)

Correspondence Address: LARSON AND LARSON, 11199 69TH STREET NORTH, LARGO, FL, 33773, US

(73) Assignee: CHARTBENDER, LLC

(21) Appl. No.: 11/114,625

(22) Filed: Apr. 26, 2005

(51) Int. Cl. G06Q 40/00

(52) U.S. Cl. 705/35

(57) ABSTRACT

A method for predicting an option's performance includes calculating three components of the set of components including decay profit and loss, implied volatility profit and loss, directional profit and loss and total option profit and loss. Once the three components are calculate, simple addition and subtraction is used to derive the fourth component and all four components are displayed to help manage profit and loss positions.

### BACKGROUND OF THE INVENTION

1. Field of the Invention

The present invention relates to a method for predicting investment performance. More specifically, it refers to a method that uses historical data to provide indices of future expectations and risk for options.

2. Description of the Prior Art

Financial management software has been around for many years. In general, financial management software gathers information about stocks, bonds, options and other financial instruments and provides various information regarding the present and past asset allocations and performance. Most of the data presented by the financial management software is historical and a user must look at a myriad of charts, graphs and numbers to predict their future positions, earnings, growth and losses. Furthermore, profit and loss is generally reported as a single value and not broken into components that may provide a more valuable summary of the instrument's performance.

What is needed is a method to predict how an option trade has performed and how it will theoretically perform in the future as well as a decomposition of the profit and loss into its component values.

### SUMMARY OF THE INVENTION

For the purposes of this application, an application may be any software program running on any computing system, for example an application designed to run under Microsoft Windows® on a personal computer utilizing an Intel processor. Profit and loss refers to the difference between the current value of an option's position and the position's initial cost. Profit and loss (P&L) can be represented in several different components, including total option P&L, implied volatility P&L, Directional P&L and Decay P&L.

Implied volatility represents the market's expectation of forthcoming volatility in the underlying asset. Therefore implied volatility P&L is the portion of an option position's overall profit and loss that may be determined specifically by a change in implied volatility. An underlying asset may include, for example, stock, indexes, currencies and futures.

Directional represents the change in price of the underlying asset. Therefore directional P&L is the portion of an option position's overall profit and loss that may be determined by changes in the underlying asset's price.

Decay represents the erosion of an option's premium due to the passage of time. Therefore decay P&L is the portion of an option position's overall profit and loss that may be determined specifically by decay.

Baseline is a point in time at which the current value of an investment is used as its cost-basis for subsequent profit and loss calculations. The baseline is automatically set everyday at the close of the market. The baseline option quantity is the number of option contracts recorded on the baseline date, while the current option quantity is the number of option contracts currently owned; perhaps some were sold.

The time to expiration is represented by the number of days between the current date and the expiration date of the option.

The assets per contract refers to the number of assets in each contract, usually 100 assets per contract.

In one embodiment, a method for predicting option performance is disclosed including calculating a total option profit and loss, calculating a decay profit and loss, calculating an implied volatility profit and loss and deriving a directional profit and loss by subtracting the implied volatility profit and loss and the decay profit and loss from the total option profit and loss.

In another embodiment, a method for predicting option performance is disclosed including calculating a total option profit and loss, calculating a decay profit and loss, calculating a directional profit and loss and deriving an implied volatility profit and loss by subtracting the directional profit and loss and the decay profit and loss from the total option profit and loss.

In another embodiment, a method for predicting option performance is disclosed including calculating a total option profit and loss, calculating an implied volatility profit and loss, calculating a directional profit and loss and deriving a decay profit and loss by subtracting the implied volatility profit and loss and the directional profit and loss from the total option profit and loss.

In another embodiment, a method for predicting option performance is disclosed including calculating an implied volatility profit and loss, calculating a decay profit and loss, calculating a directional profit and loss and deriving a total option profit and loss by adding the implied volatility profit and loss and the decay profit and loss and the directional profit and loss.

In another embodiment, a method for predicting option performance is disclosed including calculating an implied volatility profit and loss, calculating a decay profit and loss, calculating a directional profit and loss and calculating a total option profit and loss.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic block diagram of a computer system of an embodiment of the present invention.

FIG. 2 illustrates a flow diagram of an embodiment of the present invention.

FIG. 3 illustrates a flow diagram of an embodiment of the present invention.

FIG. 4 illustrates a flow diagram of an embodiment of the present invention.

FIG. 5 illustrates a flow diagram of an embodiment of the present invention.

FIG. 6 illustrates a flow diagram of an embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

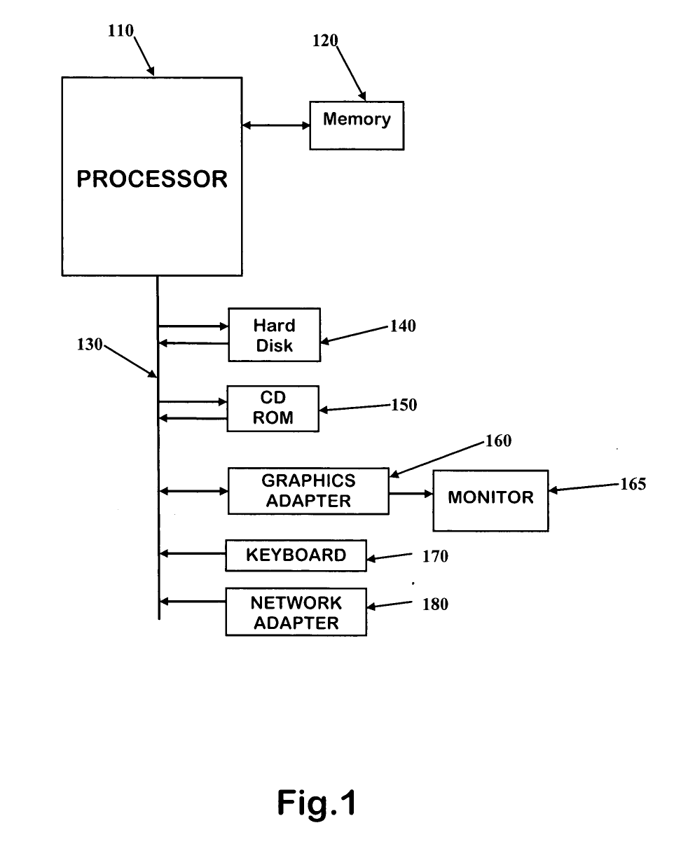

Referring to FIG. 1, a schematic block diagram of a computer-based system of the present invention is shown. In this, a processor 110 is provided to execute stored programs that are generally stored within a memory 120. The processor 110 can be any processor, perhaps an Intel Pentium-5® CPU or the like. The memory 120 is connected to the processor and can be any memory suitable for connection with the selected processor 110, such as SRAM, DRAM, SDRAM, RDRAM, DDR, DDR-2, etc.

Also connected to the processor 110 is a system bus 130 for connecting to peripheral subsystems such as a hard disk 140, a CDROM 150, a graphics adapter 160, a keyboard 170 and a network adapter 180. The graphics adapter 160 receives commands and display information from the system bus 130 and generates a display image that is displayed on the monitor 165. The monitor 165 may be any display device such as a Cathode Ray Tube (CRT), Liquid Crystal Display (LCD), Plasma display, projection display or the like.

In general, the hard disk 140 may be used to store programs, executable code and data persistently, while the CDROM 140 may be used to load the programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 130 or with other input-output functions. Examples of these devices include printers; mice; graphics tablets; joysticks; and communications adapters such as modems and Ethernet adapters.

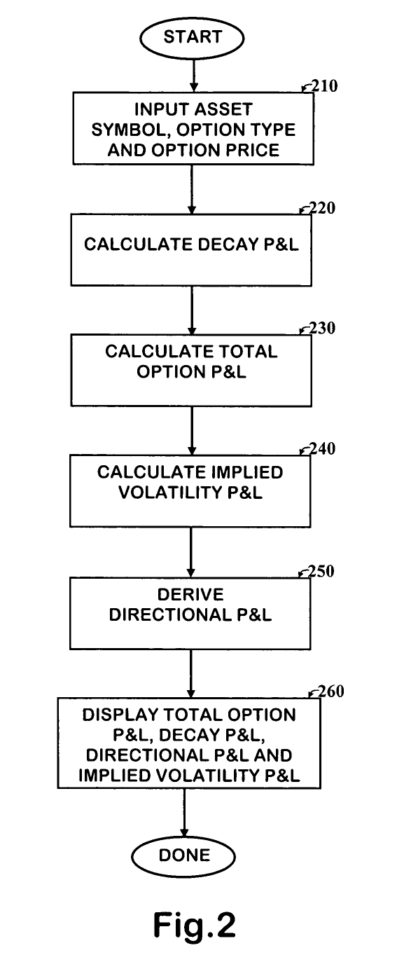

Referring now to FIG. 2, a flow diagram of the present invention is shown, starting with entering an asset symbol, option type and option price 210. The asset symbol refers to a symbol such as used on the NASDAQ or New York Stock Exchange (NYSE), for example, IBM for International Business Machines. The option type may be American Style, in that it can be exercised at any time on or before its expiration date, or European Style, in that it can only be exercised on its expiration date. The strike price is the price for which the option may be exercised, regardless of the current market price.

Next the decay profit and loss is calculated 220. The decay profit and loss is calculated by:
decay profit and loss=(np−bp)×q×apc

where np is the new price, bp is the price of the option when the baseline was set, q is quantity of contracts for the option when the baseline was set and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, baseline implied volatility and time to expiration of the option contracts as inputs. These models and approximations are known in the industry. For example, the binomial model has been proven over time to be a flexible and intuitive approach to option pricing. It is based on the premise that over a period of time, the option can only move from its current price to two possible levels. It also embodies a risk-neutral valuation principle which can be used to shortcut the valuation of European options. Certain models are better at calculating European style options while others are better at calculating American style options. These models and approximations are explained in the following references:
Chriss, Neil A. Black-Scholes and Beyond Option Pricing Models, New York: McGraw-Hill, 1997.
Haug, Espen Gaarder. The Complete Guide to Option Pricing Formulas, New York: McGraw-Hill, 1998.
Jackson, Mar and Mike Staunton, Advanced Modeling in Finance Using Excel and VBA, Chichester, England: John Wiley & Sons Ltd., 2001.
Wilmott, Paul. Paul Wilmott Introduces Quantitative Finance. Chichester, England: John Wiley & Sons Ltd., 2001.

Next the total option profit and loss is calculated 230. The total option profit and loss for long options is calculated by:
total option profit and loss=(cp−bp)×q×apc

or the total option profit and loss for short options is calculated by:
total option profit and loss=(bp−cp)×q×apc

where cp is the current option price, bp is the price of the option when the baseline was set, q is quantity of contracts for the option and apc is the number of assets per contract.

Next the implied volatility profit and loss is calculated 240. The implied volatility profit and loss is calculated by:
implied volatility profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the current asset price, baseline implied volatility and time to expiration of the option contracts as inputs. These example models and approximations are known in the industry.

Next, the directional profit and loss 250 is derived from the previous results using the following equation:
directional profit and loss=to−iv−dcy

where to is the calculated total option profit and loss, dcy is the calculated decay profit and loss and iv is the calculated implied volatility profit and loss.

Once all calculations are performed, the decay profit and loss, the total option profit and loss, the implied volatility profit and loss and the directional profit and loss are displayed 260 on a computer monitor 165, either in numerical form, graphical form or both.

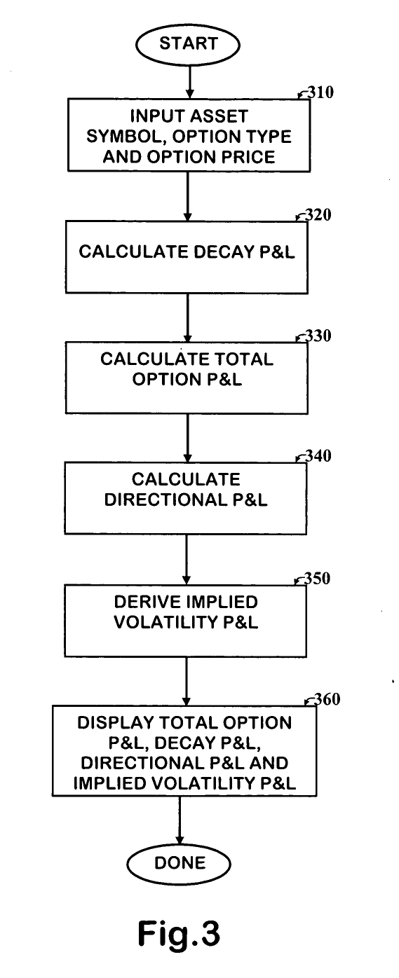

Referring now to FIG. 3, a flow diagram of the present invention is shown, starting with entering an asset symbol, option type and option price 310. The asset symbol refers to a symbol such as used on the NASDAQ or New York Stock Exchange (NYSE), for example, IBM for International Business Machines. The option type may be American Style, in that it can be exercised at any time on or before its expiration date, or European Style, in that it can only be exercised on its expiration date. The option price is the baseline (starting) price of the option.

Next the decay profit and loss is calculated 320. The decay profit and loss is calculated by:
decay profit and loss=(np−bp)×q×apc

where np is the new price, bp is the price of the option when the baseline was set, q is quantity of contracts for the option when the baseline was set and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, baseline implied volatility and time to expiration of the option contracts as inputs. These models and approximations are known in the industry. For example, the binomial model has been proven over time to be a flexible and intuitive approach to option pricing. It is based on the premise that over a period of time, the option can only move from its current price to two possible levels. It also embodies a risk-neutral valuation principle which can be used to shortcut the valuation of European options. Certain models are better at calculating European style options while others are better at calculating American style options.

Next the total option profit and loss is calculated 330. The total option profit and loss for long options is calculated by:
total option profit and loss=(cp−bp)×q×apc

or the total option profit and loss for short options is calculated by:
total option profit and loss=(bp−cp)×q×apc

where cp is the current option price, bp is the price of the option when the baseline was set, q is quantity of contracts for the option and apc is the number of assets per contract.

Next the directional profit and loss is calculated 340. The directional profit and loss is calculated by:
directional profit and loss=(cp−np)×q×apc

where np is the new price, cp is the current option price, q is current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, the current implied volatility and time to expiration as inputs. These example models and approximations are known in the industry.

Next, the implied volatility profit and loss 350 is derived from the previous results using the following equation:
implied volatility profit and loss=to−d−dcy

where to is the calculated total option profit and loss, d is the calculated directional profit and loss and dcy is the calculated decay profit and loss.

Once all calculations are performed, the decay profit and loss, the total option profit and loss, the implied volatility profit and loss and the directional profit and loss are displayed 360 on a computer monitor 165, either in numerical form, graphical form or both.

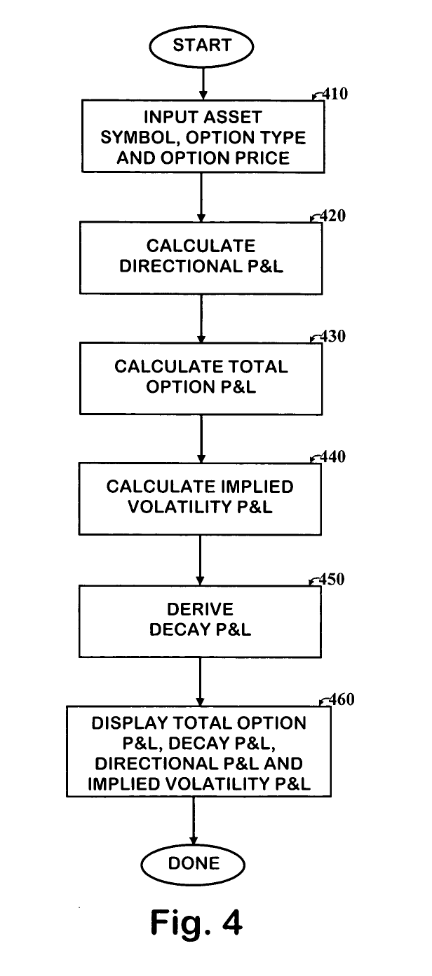

Referring now to FIG. 4, a flow diagram of the present invention is shown, starting with entering an asset symbol, option type and option price 410. The asset symbol refers to a symbol such as used on the NASDAQ or New York Stock Exchange (NYSE), for example, IBM for International Business Machines. The option type may be American Style, in that it can be exercised at any time on or before its expiration date, or European Style, in that it can only be exercised on its expiration date. The option price is the baseline (starting) price of the option.

Next the directional profit and loss is calculated 420. The directional profit and loss is calculated by:
directional profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, the current implied volatility and time to expiration as inputs. These example models and approximations are known in the industry.

Next the total option profit and loss is calculated 430. The total option profit and loss for long options is calculated by:
total option profit and loss=(cp−bp)×q×apc

or the total option profit and loss for short options is calculated by:
total option profit and loss=(bp−cp)×q×apc

where cp is the current option price, bp is the price of the option when the baseline was set, q is quantity of contracts for the option and apc is the number of assets per contract.

Next the implied volatility profit and loss is calculated 440. The implied volatility profit and loss is calculated by:
implied volatility profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the current asset price, baseline implied volatility and time to expiration of the option contracts as inputs. These example models and approximations are known in the industry.

Next, the decay profit and loss 450 is derived from the previous results using the following equation:
decay profit and loss=to−d−iv

where to is the calculated total option profit and loss, d is the calculated directional profit and loss and iv is the calculated implied volatility profit and loss.

Once all calculations are performed, the decay profit and loss, the total option profit and loss, the implied volatility profit and loss and the directional profit and loss are displayed 460 on a computer monitor 165, either in numerical form, graphical form or both.

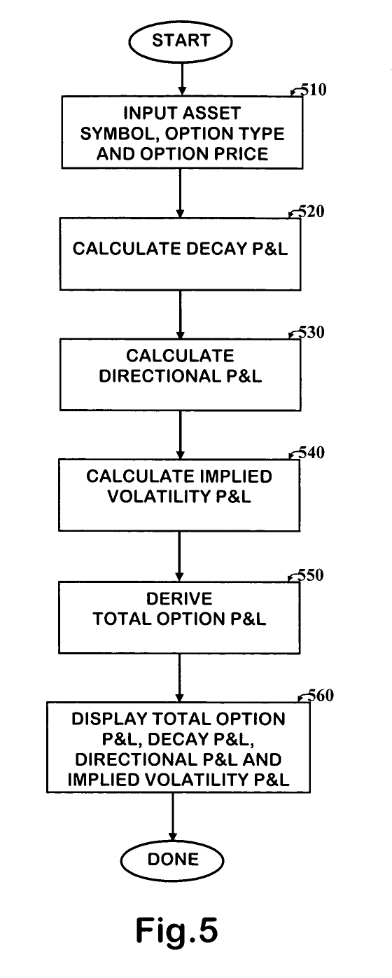

Referring now to FIG. 5, a flow diagram of the present invention is shown, starting with entering an asset symbol, option type and option price 510. The asset symbol refers to a symbol such as used on the NASDAQ or New York Stock Exchange (NYSE), for example, IBM for International Business Machines. The option type may be American Style, in that it can be exercised at any time on or before its expiration date, or European Style, in that it can only be exercised on its expiration date. The option price is the baseline (starting) price of the option.

Next the decay profit and loss is calculated 520. The decay profit and loss is calculated by:
decay profit and loss=(np−bp)×q×apc

where np is the new price, bp is the price of the option when the baseline was set , q is quantity of contracts for the option when the baseline was set and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, baseline implied volatility and time to expiration of the option contracts as inputs. These models and approximations are known in the industry. For example, the binomial model has been proven over time to be a flexible and intuitive approach to option pricing. It is based on the premise that over a period of time, the option can only move from its current price to two possible levels. It also embodies a risk-neutral valuation principle which can be used to shortcut the valuation of European options. Certain models are better at calculating European style options while others are better at calculating American style options.

Next the directional profit and loss is calculated 530. The directional profit and loss is calculated by:
directional profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, the current implied volatility and time to expiration as inputs. These example models and approximations are known in the industry.

Next the implied volatility profit and loss is calculated 540. The implied volatility profit and loss is calculated by:
implied volatility profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the current asset price, baseline implied volatility and time to expiration of the option contracts as inputs. These example models and approximations are known in the industry.

Next, the total option profit and loss 550 is derived from the previous results using the following equation:
total option profit and loss=d+iv+dcy

where d is the calculated directional profit and loss, iv is the calculated implied volatility profit and loss and dcy is the calculated decay profit and loss.

Once all calculations are performed, the decay profit and loss, the total option profit and loss, the implied volatility profit and loss and the directional profit and loss are displayed 560 on a computer monitor 165, either in numerical form, graphical form or both.

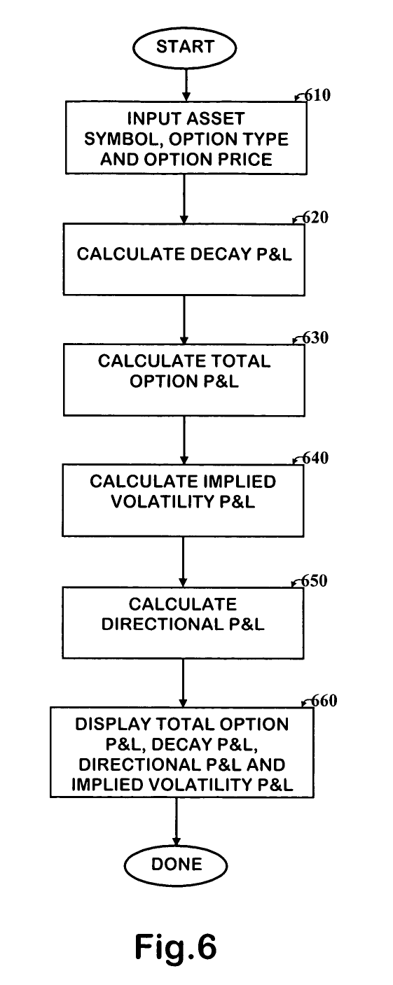

Referring now to FIG. 6, a flow diagram of the present invention is shown, starting with entering an asset symbol, option type and option price 610. The asset symbol refers to a symbol such as used on the NASDAQ or New York Stock Exchange (NYSE), for example, IBM for International Business Machines. The option type may be American Style, in that it can be exercised at any time on or before its expiration date, or European Style, in that it can only be exercised on its expiration date. The option price is the baseline (starting) price of the option.

Next the decay profit and loss is calculated 620. The decay profit and loss is calculated by:
decay profit and loss=(np−bp)×q×apc

where np is the new price, bp is the price of the option when the baseline was set, q is quantity of contracts for the option when the baseline was set and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, baseline implied volatility and time to expiration of the option contracts as inputs. These models and approximations are known in the industry. For example, the binomial model has been proven over time to be a flexible and intuitive approach to option pricing. It is based on the premise that over a period of time, the option can only move from its current price to two possible levels. It also embodies a risk-neutral valuation principle which can be used to shortcut the valuation of European options. Certain models are better at calculating European style options while others are better at calculating American style options.

Next the total option profit and loss is calculated 630. The total option profit and loss for long options is calculated by:
total option profit and loss=(cp−bp)×q×apc

or the total option profit and loss for short options is calculated by:
total option profit and loss=(bp−cp)×q×apc

where cp is the current option price, bp is the price of the option when the baseline was set, q is quantity of contracts for the option and apc is the number of assets per contract.

Next the implied volatility profit and loss is calculated 640. The implied volatility profit and loss is calculated by:
implied volatility profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the current asset price, baseline implied volatility and time to expiration of the option contracts as inputs. These example models and approximations are known in the industry.

Next the directional profit and loss is calculated 650. The directional profit and loss is calculated by:
directional profit and loss=(cp−np)×q×apc

where np is the new price, cp is the current option price, q is the current quantity of contracts for the option and apc is the number of assets per contract. New price, np, is calculated using a standard pricing model such as the Binomial Model, the Trinomial Model, the Black-Sholes Model, the Barone-Adesi and Whaley Approximation and the Bjerksund and Stensland Approximation, using the baseline asset price, the current implied volatility and time to expiration as inputs. These example models and approximations are known in the industry.

Once all calculations are performed, the decay profit and loss, the total option profit and loss, the implied volatility profit and loss and the directional profit and loss are displayed 660 on a computer monitor 165, either in numerical form, graphical form or both.

An example of the use of these equations will be shown using sample numbers in the tables below. Table-1 shows baseline numbers for the sample option when purchased on April 13. Table-2 shows closing prices for that option on April 13. Table-3 shows the profit and loss breakdowns for those options on April 14.

TABLE 1
Baseline Date Apr. 13, 2005

| DESCRIPTION/ | | BASELINE |
|---|---|---|
| STRIKE PRICE | QUANTITY | PRICE |
| June 2005 - 150 Put | 1 | 11.75 |
| June 2005 - 135 Put | 1 | 5.50 |

TABLE 2
Closing Prices Apr. 13, 2005 (Current Price)

| DESCRIPTION/ | | BASELINE |
|---|---|---|
| STRIKE PRICE | QUANTITY | PRICE |
| June 2005 - 150 Put | 1 | 11.75 |
| June 2005 - 135 Put | 1 | 5.50 |

TABLE 3
Sources of P&L on Apr. 14, 2005

| DESCRIPTION/ | TOTAL | DIRECTIONAL | IV | DECAY |
|---|---|---|---|---|
| STRIKE PRICE | P&L | P&L | P&L | P&L |
| June 2005 - 150 Put | 395 | 332.31 | 69.88 | −7.19 |
| June 2005 - 135 Put | 235 | 206.60 | 34.94 | −6.54 |

In both cases, one option contract was purchased (quantity=1) with the standard 100 assets per contract (apc=100) and the time to expiration is 57 days. Total option profit and loss may be calculated by:
total option P&L=(cp−bp)×q×apc

Inserting the values from this example:
total option P&L₁₅₀=395=(15.70−11.75)×1×100
total option P&L₁₃₅=235=(7.85−5.50)×1×100

Implied volatility profit and loss may be calculated by:
implied volatility P&L=(cp−np)×q×apc

where np is calculated using the binomial(cp, strike, time to expiration)

Inserting the values from this example:
implied volatility P&L₁₅₀=69.88=(15.70−15.0012)×1×100

where np is calculated using the binomial(15.70, 150, 57)
implied volatility P&L₁₃₅=34.94=(7.85−7.5006)×1×100

where np is calculated using the binomial(7.85, 135, 57)

Decay profit and loss may be calculated by:
decay P&L=(np−bp)×q×apc

where np is calculated using the binomial(bp, strike, time to expiration)

Inserting the values from this example:
decay P&L₁₅₀=−7.19=(11.6781−11.75)×1×100

where np is calculated using the binomial(11.75, 150, 57)
decay P&L₁₃₅=−6.54=(7.85−7.5006)×1×100

where np is calculated using the binomial(7.85, 135, 57)

Directional profit and loss may be calculated by:
Directional P&L=Total Option−Implied Volatility−Decay

Inserting the values from this example:
Directional P&L₁₅₀=332.31=395.00−69.88−(−7.19)
Directional P&L₁₃₅=206.60=235.00−34.94−(−6.54)

Equivalent elements can be substituted for the ones set forth above such that they perform in substantially the same manner in the same way for achieving the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for predicting option performance comprising:
calculating a total option profit and loss;
calculating a decay profit and loss;
calculating an implied volatility profit and loss; and
deriving a directional profit and loss by subtracting the implied volatility profit and loss and the decay profit and loss from the total option profit and loss.

2. The method for predicting option performance of claim 1, whereas the calculating the decay profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a baseline implied volatility and a time to expiration as input parameters.

3. The method for predicting option performance of claim 1, whereas the calculating the implied volatility profit and loss is performed by using at least one pricing model selected from the set of pricing models comprising a trinomial model; a binomial model; a Black-Scholes model; a Barone-Adesi and Whaley approximation; and a Bjerksund and Stensland approximation using a current asset price, a baseline implied volatility and a time to expiration as input parameters.

4. The method for predicting option performance of claim 1, further comprising displaying the total option profit and loss, the decay profit and loss, the implied volatility profit and loss and the directional profit and loss on a monitor.

5. The method for predicting option performance of claim 1, whereas the calculating the total option profit and loss is performed by subtracting a baseline option price from a current option price and multiplying by an option quantity and multiplying by a number of assets per contract.

6. The method for predicting option performance of claim 1, whereas the calculating the total option profit and loss is performed by subtracting a current option price from a baseline option price and multiplying by an option quantity and multiplying by a number of assets per contract.

7. The method for predicting option performance of claim 1, whereas the calculating the decay profit and loss is performed by subtracting a baseline option price from a new price and multiplying by a baseline option quantity and multiplying by a number of assets per contract, and whereas the calculating the implied volatility profit and loss is performed by subtracting the new price from a current option price and multiplying by a current option quantity and the number of assets per contract, whereas the new price is calculated using a financial model selected from the group of pricing models comprising a trinomial model; a binomial model; a Black-Scholes model; a Barone-Adesi and Whaley approximation; and a Bjerksund and Stensland approximation.

8. The method for predicting option performance of claim 1, whereas the deriving the directional profit and loss is computed by subtracting the decay profit and loss and subtracting the implied volatility profit and loss from the total option profit and loss.

9. A method for predicting option performance comprising:
calculating a total option profit and loss;
calculating a decay profit and loss;
calculating a directional profit and loss; and
deriving an implied volatility profit and loss by subtracting the directional profit and loss and the decay profit and loss from the total option profit and loss.

10. The method for predicting option performance of claim 9, whereas the calculating the decay profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a baseline implied volatility and a time to expiration as input parameters.

11. The method for predicting option performance of claim 9, whereas the calculating the directional profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a current implied volatility and a time to expiration as input parameters.

12. The method for predicting option performance of claim 9, further comprising displaying the total option profit and loss, the decay profit and loss, the implied volatility profit and loss and the directional profit and loss on a monitor.

13. The method for predicting option performance of claim 9, whereas the calculating the total option profit and loss is performed by subtracting a baseline option price from a current option price and multiplying by an option quantity and multiplying by a number of assets per contract.

14. The method for predicting option performance of claim 9, whereas the calculating the total option profit and loss is performed by subtracting a current option price from a baseline option price and multiplying by an option quantity and multiplying by a number of assets per contract.

15. The method for predicting option performance of claim 9, whereas the calculating the decay profit and loss is performed by subtracting a baseline option price from a new price and multiplying by a baseline option quantity and multiplying by a number of assets per contract, and whereas the calculating the directional profit and loss is performed by subtracting the new price from a current option price and multiplying by a current option quantity and the number of assets per contract, whereas the new price is calculated using a financial model selected from the group of pricing models comprising a trinomial model; a binomial model; a Black-Scholes model; a Barone-Adesi and Whaley approximation; and a Bjerksund and Stensland approximation.

16. The method for predicting option performance of claim 9, whereas the deriving the implied volatility profit and loss is computed by subtracting the decay profit and loss and subtracting the directional profit and loss from the total option profit and loss.

17. A method for predicting option performance comprising:
calculating a total option profit and loss;
calculating a implied volatility profit and loss;
calculating a directional profit and loss; and
deriving a decay profit and loss by subtracting the implied volatility profit and loss and the directional profit and loss from the total option profit and loss.

18. The method for predicting option performance of claim 17, whereas the calculating the implied volatility profit and loss is performed by using at least one pricing model selected from the set of pricing models comprising a trinomial model; a binomial model; a Black-Scholes model; a Barone-Adesi and Whaley approximation; and a Bjerksund and Stensland approximation using a current asset price, a baseline implied volatility and a time to expiration as input parameters.

19. The method for predicting option performance of claim 17, whereas the calculating the directional profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a current implied volatility and a time to expiration as input parameters.

20. The method for predicting option performance of claim 17, further comprising displaying the total option profit and loss, the decay profit and loss, the implied volatility profit and loss and the directional profit and loss on a monitor.

21. The method for predicting option performance of claim 17, whereas the calculating the total option profit and loss is performed by subtracting a baseline option price from a current option price and multiplying by an option quantity and multiplying by a number of assets per contract.

22. The method for predicting option performance of claim 17, whereas the calculating the total option profit and loss is performed by subtracting a current option price from a baseline option price and multiplying by an option quantity and multiplying by a number of assets per contract.

23. The method for predicting option performance of claim 17, whereas the calculating the implied volatility profit and loss is performed by subtracting a new price from a current option price and multiplying by a current option quantity and multiplying by a number of assets per contract, and whereas the calculating the directional profit and loss is performed by subtracting the new price from the current option price and multiplying by a current option quantity and the number of assets per contract, whereas the new price is calculated using a financial model selected from the group of pricing models comprising a trinomial model; a binomial model; a Black-Scholes model; a Barone-Adesi and Whaley approximation; and a Bjerksund and Stensland approximation.

24. The method for predicting option performance of claim 17, whereas the deriving the decay profit and loss is computed by subtracting the implied volatility profit and loss and subtracting the directional profit and loss from the total option profit and loss.

25. A method for predicting option performance comprising:
calculating an implied volatility profit and loss;
calculating a decay profit and loss;
calculating a directional profit and loss; and
deriving a total option profit and loss by adding the implied volatility profit and loss and the decay profit and loss and the directional profit and loss.

26. The method for predicting option performance of claim 25, whereas the calculating the decay profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a baseline implied volatility and a time to expiration as input parameters.

27. The method for predicting option performance of claim 25, whereas the calculating the directional profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a current implied volatility and a time to expiration as input parameters.

28. The method for predicting option performance of claim 25, whereas the calculating the implied volatility profit and loss is performed by using at least one pricing model selected from the set of pricing models comprising a trinomial model; a binomial model; a Black-Scholes model; a Barone-Adesi and Whaley approximation; and a Bjerksund and Stensland approximation using a current asset price, a baseline implied volatility and a time to expiration as input parameters.

29. The method for predicting option performance of claim 25, further comprising displaying the total option profit and loss, the decay profit and loss, the implied volatility profit and loss and the directional profit and loss on a monitor.

30. The method for predicting option performance of claim 25, whereas the calculating the decay profit and loss is performed by subtracting a baseline option price from a new price and multiplying by a baseline option quantity and multiplying by a number of assets per contract, and whereas the calculating the directional profit and loss is performed by subtracting the new price from a current option price and multiplying by a current option quantity and the number of assets per contract, and whereas the calculating the implied volatility profit and loss is performed by subtracting the new price from the current option price and multiplying by the current option quantity and the number of assets per contract, whereas the new price is calculated using a financial model selected from the group of pricing models comprising a trinomial model; a binomial model; a Black-Scholes model; a Barone-Adesi and Whaley approximation; and a Bjerksund and Stensland approximation.

31. The method for predicting option performance of claim 25, whereas the deriving the total option profit and loss is computed by adding the decay profit and loss and the directional profit and loss and the implied volatility profit and loss.

32. A method for predicting option performance comprising:
calculating an implied volatility profit and loss;
calculating a decay profit and loss;
calculating a directional profit and loss; and
calculating a total option profit and loss.

33. The method for predicting option performance of claim 32, whereas the calculating the decay profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a baseline implied volatility and a time to expiration as input parameters.

34. The method for predicting option performance of claim 32, whereas the calculating the implied volatility profit and loss is performed by using at least one pricing model selected from the set of pricing models comprising a trinomial model; a binomial model; a Black-Scholes model; a Barone-Adesi and Whaley approximation; and a Bjerksund and Stensland approximation using a current asset price, a baseline implied volatility and a time to expiration as input parameters.

35. The method for predicting option performance of claim 32, whereas the calculating the directional profit and loss is performed by using at least one pricing model selected from the set of pricing models comprising a trinomial model; a binomial model; a Black-Scholes model; a Barone-Adesi and Whaley approximation; and a Bjerksund and Stensland approximation using a baseline asset price, a current implied volatility and a time to expiration as input parameters.

36. The method for predicting option performance of claim 32, further comprising displaying the total option profit and loss, the decay profit and loss, the implied volatility profit and loss and the directional profit and loss on a monitor.

37. The method for predicting option performance of claim 32, whereas the calculating the decay profit and loss is performed by subtracting a baseline option price from a new price and multiplying by a baseline option quantity and multiplying by a number of assets per contract, and whereas the calculating the directional profit and loss is performed by subtracting the new price from a current option price and multiplying by a current option quantity and the number of assets per contract, and whereas the calculating the implied volatility profit and loss is performed by subtracting the new price from the current option price and multiplying by the current option quantity and the number of assets per contract, whereas the new price is calculated using a financial model selected from the group of pricing models comprising a trinomial model; a binomial model; a Black-Scholes model; a Barone-Adesi and Whaley approximation; and a Bjerksund and Stensland approximation.

38. The method for predicting option performance of claim 32, whereas the calculating the total option profit and loss is performed by subtracting a current option price from a baseline option price and multiplying by an option quantity and multiplying by a number of assets per contract.

39. The method for predicting option performance of claim 32, whereas the calculating the total option profit and loss is performed by subtracting a baseline option price from a current option price and multiplying by an option quantity and multiplying by a number of assets per contract.
